(19) United States
(12) Patent Application Publication
(10) Pub. No.: US 2026/0058577 A1
(43) Pub. Date: Feb. 26, 2026

(54) PIEZOELECTRIC MOTOR AND ELECTRONIC DEVICE

(71) Applicant: Luxshare Intelligent Manufacture Technology (Changshu) Co., Ltd, Changshu City (CN)

(72) Inventor: Po-Ying TSENG, Changshu City (CN)

(73) Assignee: Luxshare Intelligent Manufacture Technology (Changshu) Co., Ltd, Changshu City (CN)

(21) Appl. No.: 18/970,297

(22) Filed: Dec. 5, 2024

(30) Foreign Application Priority Data
Aug. 26, 2024 (CN) 202411173649.3

(51) Int. Cl. H02N 2/10; H02N 2/12

(52) U.S. Cl. CPC H02N 2/103; H02N 2/12

(57) ABSTRACT

A piezoelectric motor includes a fixed component, a piezoelectric member and a movable member. The fixed component is provided with a friction surface. The piezoelectric member is provided with a piezoelectric friction head, and the piezoelectric friction head is configured to abut against the friction surface, to enable the piezoelectric member to be moveable relative to the fixed component. The movable member is connected to the piezoelectric member, and the movement of the piezoelectric member is configured to drive the movable member to move relative to the fixed component.

### CROSS-REFERENCE TO RELATED APPLICATION(S)

This application claims priority to Chinese Patent Application No. 202411173649.3 filed Aug. 26, 2024, the disclosure of which is incorporated herein by reference in its entirety.

### TECHNICAL FIELD

The present application relates to the field of piezoelectric technology, and in particular to a piezoelectric motor and an electronic device.

### BACKGROUND

Piezoelectric motors are widely used in electronic devices such as Augmented Reality (AR), Virtual Reality (VR) and camera modules due to their characteristics such as small size and stable driving, so as to drive the displacement and deformation of optical modules, switches, reeds or any components.

In the related art, a piezoelectric motor generally includes two fixed parts arranged opposite to each other in one direction, two groups of piezoelectric members respectively connected to the two fixed parts, and a movable part located between the two groups of piezoelectric members. The two groups of piezoelectric members are arranged opposite to each other in one direction, and both can contact a friction surface of the movable part, so that the piezoelectric members can drive the movable part to move in another direction. However, in order to ensure that the friction surface of the movable part can always contact the piezoelectric members during the movement of the movable part, the size of the movable part needs to be designed large, generally greater than or equal to the size of the piezoelectric members plus twice a required stroke, and a space of at least one time a stroke needs to be reserved in front and behind the movable part in the above-mentioned another direction for the movable part to use, resulting in the piezoelectric motor in the related art being large in size and hardly to be used in electronic devices with high size requirements.

Therefore, a piezoelectric motor and an electronic device are urgently needed to solve the above problems.

### SUMMARY

Embodiments of the present application provide a piezoelectric motor.

A piezoelectric motor, includes: a fixed component, a piezoelectric member and a movable member.

The fixed component is provided with a friction surface.

The piezoelectric member is provided with a piezoelectric friction head, and the piezoelectric friction head is configured to abut against the friction surface, to enable the piezoelectric member to be moveable relative to the fixed component.

The movable member is connected to the piezoelectric member, and the piezoelectric member is configured to move to drive the movable member to move relative to the fixed component.

In some embodiments, the piezoelectric motor further includes a flexible connecting member, one end of the flexible connecting member is connected to the fixed component and is electrically connected to a signal source, the other end of the flexible connecting member is bent toward the piezoelectric member or the movable member and is connected to at least one of the piezoelectric member and the movable member, and the flexible connecting member is electrically connected to the piezoelectric member.

In some embodiments, the movable member is provided with a notch, the other end of the flexible connecting member is connected to a notch wall of the notch, and the notch extends from one side of the movable member to an outer surface of the movable member in the moving direction of the movable member. The flexible connecting member includes a first connection state and a second connection state, and when the flexible connecting member is in the first connection state, a bent part of the flexible connecting member is placed in the notch. When the flexible connecting member is in the second connection state, the bent part of the flexible connecting member is entirely or partially located outside the notch.

In some embodiments, the movable member is a conductor, and the flexible connecting member is electrically connected to the piezoelectric member through the movable member.

In some embodiments, the piezoelectric motor further includes a conductive structure and a connecting component. The conductive structure extends in a moving direction of the movable member and is electrically connected to a signal source. One end of the connecting component is in sliding contact with and electrically connected to the conductive structure, and the other end of the connecting component is arranged on at least one of the piezoelectric member and the movable member and is electrically connected to the piezoelectric member.

In some embodiments, the connecting component includes a conductive member and a carbon brush arranged on and electrically connected to the conductive member. The conductive member is arranged on at least one of the piezoelectric member and the movable member and is electrically connected to the piezoelectric member, and the carbon brush is in sliding contact with and electrically connected to the conductive structure.

In some embodiments, the conductive member is electrically connected to the movable member, the movable member is electrically connected to the piezoelectric member, the movable member and the carbon brush are arranged on opposite sides of the conductive member, and the conductive member is bent toward the movable member.

In some embodiments, the fixed component includes a housing, a fixed member and an elastic member. The fixed member and the elastic member are both arranged in the housing, the friction surface is provided on the fixed member, and the elastic member abuts between an inner wall of the housing and the fixed member, and is configured to drive the fixed member to have a tendency to abut against the piezoelectric member.

In some embodiments, the fixed member includes a first fixed part and two second fixed parts, the two second fixed parts are spaced and connected to a same side of the first fixed part, the friction surface is provided on the first fixed part, and the elastic member abuts against the first fixed part.

Surfaces of the two second fixed parts facing away from each other are provided with protrusions respectively, and the protrusions are configured to abut against inner walls of the housing.

In some embodiments, the elastic member includes an arc-shaped part and two abutment parts connected to two ends of the arc-shaped part, the arc-shaped part abuts against the fixed member, and the abutment parts abut against the inner walls of the housing.

In some embodiments, the piezoelectric motor further includes a guide structure extending in a first direction, and the movable member is slidably matched with the guide structure and is slidable in the extension direction of the guide structure.

Embodiments of the present application further provide an electronic device having a smaller size.

An electronic device includes the piezoelectric motor as described above.

### BRIEF DESCRIPTION OF DRAWINGS

In order to more clearly illustrate the technical solutions in the embodiments of the present application, the drawings required for the description of the embodiments of the present application are briefly introduced below. Obviously, the drawings described below are only some embodiments of the present application. For a person of ordinary skills in the art, other drawings can be obtained based on the contents of the embodiments of the present application and these drawings without making creative efforts.

FIG. 1 is schematic structural diagram one of a piezoelectric motor provided in one or more embodiments of the present application;

FIG. 2 is schematic structural diagram two of a piezoelectric motor provided in one or more embodiments of the present application;

FIG. 3 is a bottom view of a piezoelectric motor provided in one or more embodiments of the present application;

FIG. 4 is a schematic exploded view of a piezoelectric motor provided in one or more embodiments of the present application;

FIG. 5 is a reference diagram of a piezoelectric motor in use provided in one or more embodiments of the present application;

FIG. 6 is schematic structural diagram one of another piezoelectric motor provided in one or more embodiments of the present application;

FIG. 7 is schematic structural diagram two of another piezoelectric motor provided in one or more embodiments of the present application;

FIG. 8 is a partial schematic structural diagram of another piezoelectric motor provided in one or more embodiments of the present application;

FIG. 9 is a reference diagram of another piezoelectric motor in use provided in one or more embodiments of the present application;

FIG. 10 is a partial schematic diagram of an electronic device provided in one or more embodiments of the present application;

FIG. 11 is a partial schematic diagram of another electronic device provided in one or more embodiments of the present application; and

FIG. 12 is a partial schematic diagram of another electronic device provided in one or more embodiments of the present application.

### REFERENCE NUMERALS LIST

10 piezoelectric motor
100 fixed component
110 friction surface
120 housing
130 fixed member
131 first fixed part
132 second fixed part
1321 protrusion
140 elastic member
141 arc-shaped part
142 abutment part
200 piezoelectric member
210 piezoelectric friction head
300 movable member
310 notch
400 flexible connecting member
410 first end
420 second end
430 bent part
500 conductive structure
510 first metal layer
520 second metal layer
600 connecting component
61 conductive member
610 first spring sheet
620 second spring sheet
700 carbon brush
800 guide structure
20 moving member
X first direction
Y second direction
Z third direction

### DETAILED DESCRIPTION

In order to make the technical problems solved, the technical solutions adopted and the technical effects achieved by the present application clearer, the technical solutions of the present application are further explained in conjunction with the drawings and through embodiments. It can be understood that the embodiments described here are only intended to explain the present application, rather than limiting the present application. It should also be noted that, for the convenience of description, only the parts related to the present application rather than all are shown in the drawings.

It is to be noted that similar reference numerals and letters represent similar terms in the following drawings. Therefore, once an item is defined in a drawing, it does not need to be further defined or explained in subsequent drawings.

In the description of the present application, it is to be noted that, unless otherwise expressly specified and limited, the terms “connected to each other”, “connected” or “fixed” are to be construed in a broad sense, for example, as permanently connected or detachably connected or integrally formed; mechanically connected or electrically connected; directly connected to each other or indirectly connected to each other via an intermediary; or internally connection of two components or interaction relationship between two components. For those of ordinary skill in the art, specific meanings of the preceding terms in the present application may be construed based on specific situations.

In the present application, unless otherwise expressly specified and limited, when a first feature is described as “above” or “below” a second feature, the first feature and the second feature may be in direct contact, or be in contact via another feature between the two features. Moreover, when the first feature is described as “on”, “above” or “over” the second feature, the first feature is right on, above or over the second feature or the first feature is obliquely on, above or over the second feature; or the first feature is simply at a higher level than the second feature. When the first feature is described as “under”, “below” or “underneath” the second feature, the first feature is right under, below or underneath the second feature or the first feature is obliquely under, below or underneath the second feature, or the first feature is simply at a lower level than the second feature. In the description of the embodiments, unless otherwise specified, “multiple” specifically refers to two or more.

In the description of this article, it should be understood that the orientation or position relationships indicated by the terms such as “upper”, “lower”, “left”, “right”, etc., are based on the orientation or position relationship shown in the drawings, which is only for the convenience of description and simplification of operation, and does not indicate or imply that the device or element referred to must have a specific orientation, be constructed and operated in a specific orientation, and therefore cannot be understood as a limitation of the present application. Furthermore, the terms “first” and “second” are only used to distinguish in the description and have no special meaning.

It should be noted that when an element is referred to as being “fixed to” or “set on” another element, it may be directly on the other element or there may be a central element.

### Embodiment One

A piezoelectric motor is provided according to one or more embodiments, which has a small outer size and is applied in electronic devices with high size requirements.

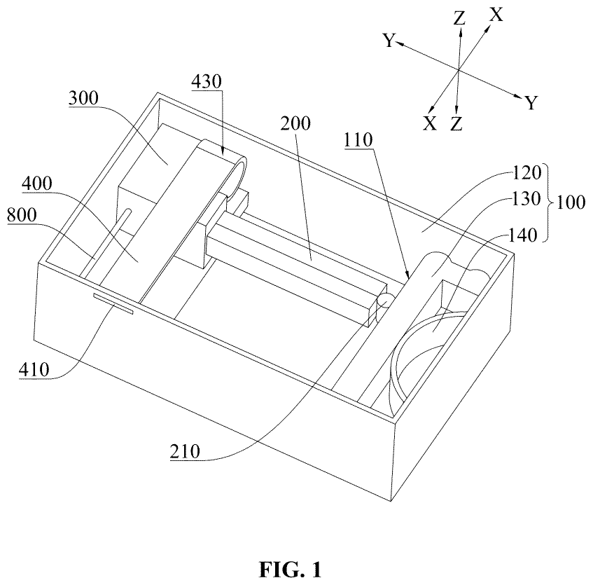

As shown in FIG. 1 to FIG. 5, the piezoelectric motor 10 includes a fixed component 100, a piezoelectric member 200 and a movable member 300. The piezoelectric member 200 and the movable member 300 are both movably connected to the fixed component 100.

The fixed component 100 is provided with a friction surface 110. In some embodiments, the roughness or friction coefficient of the friction surface 110 is large so that it contacts with other objects and generates a large friction force.

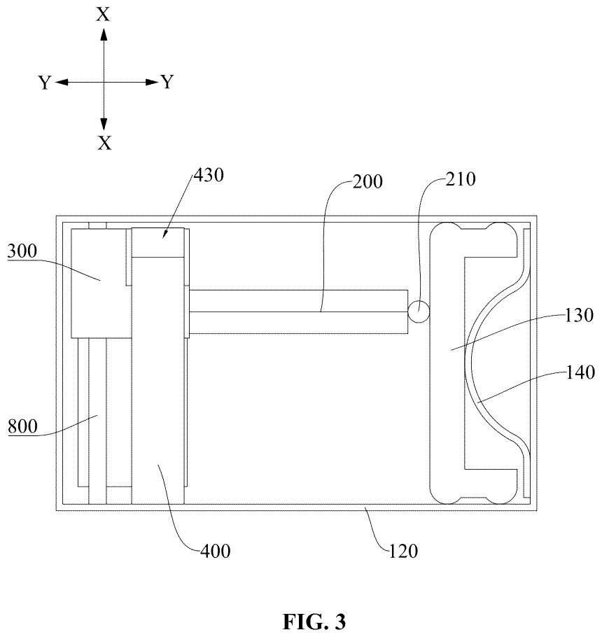

For example, reference is made to FIG. 3, the piezoelectric member 200 is provided with a piezoelectric friction head 210. The piezoelectric friction head 210 is arranged toward the friction surface 110, and the piezoelectric friction head 210 abuts against the friction surface 110, so that the piezoelectric member 200 is capable of moving relative to the fixed component 100 after being energized and deformed. For example, a piezoelectric signal is transmitted to the piezoelectric member 200 by an external signal source (not shown in the figure), and the piezoelectric member 200 is deformed under the action of the piezoelectric signal. When the piezoelectric member 200 is deformed, it drives the piezoelectric friction head 210 to move relative to the friction surface 110 to generate a friction force. Since the fixed component 100 is fixed, the entire piezoelectric member 200 slides in a predetermined direction relative to the fixed component 100. In this embodiment, the movable member 300 is connected to the piezoelectric member 200, and the movement of the piezoelectric member 200 is configured to drive the movable member 300 to move relative to the fixed component 100, thereby driving the movable member 300. The movable member 300 is connected to a moving member 20 of the electronic device, and is configured to drive the moving member 20 to move in a specific direction. Examples of signal sources are controllers, mainboards, etc., which are not limited in this embodiment.

For example, as shown in FIG. 1, a first direction X, a second direction Y and a third direction Z are provided in the drawings of this embodiment, and any two of the first direction X, the second direction Y and the third direction Z are perpendicular to each other. The moving direction of the piezoelectric member 200 and the movable member 300 may be the first direction X, and the piezoelectric member 200 and the friction surface 110 are arranged opposite to each other in the second direction Y. For example, the fixed component 100 may be in the shape of a rectangular parallelepiped, the first direction X may be a width direction of the fixed component 100, the second direction Y may be a length direction of the fixed component 100, and the third direction Z may be a height direction of the fixed component 100, which is not limited in this embodiment.

In the piezoelectric motor 10 provided in this embodiment, the fixed component 100 is provided with a friction surface 110, the piezoelectric member 200 is in contact with the friction surface 110 through the piezoelectric friction head 210, so that the piezoelectric member 200 can move relative to the fixed component 100, and the movable member 300 is connected to the piezoelectric member 200, so that the movable member 300 and the piezoelectric member 200 move synchronously relative to the fixed component 100. The friction surface 110 is set on the fixed component 100, but not on the movable member 300, so that the size of the movable member 300 does not need to be designed large, and the movable member 300 does not need to reserve at least one time a stroke space in the moving direction, but may just move within a set stroke, and a required moving stroke of the piezoelectric member 200 may also be equal to the set stroke, and does not need to be set greater than the set stroke. The length of the friction surface 110 may also be equal to the set stroke, and does not need to be set greater than the set stroke, so that the overall size of the piezoelectric motor 10 is small, which facilitates miniaturization of the piezoelectric motor 10, and enables the piezoelectric motor 10 to be applied in electronic devices with high size requirements, and to have a wider range of applications.

Exemplarily, as shown in FIG. 1, the piezoelectric motor 10 further includes a flexible connecting member 400. One end of the flexible connecting member 400 is connected to the fixed component 100 and is electrically connected to the signal source, so that the one end of the flexible connecting member 400 is relatively fixed. The other end of the flexible connecting member 400 is bent toward the piezoelectric member 200 or the movable member 300 and is connected to at least one of the piezoelectric member 200 and the movable member 300, and the flexible connecting member 400 is electrically connected to the piezoelectric member 200. Exemplarily, the signal source is capable of transmitting piezoelectric signals and electrical energy to the piezoelectric member 200 through the flexible connecting member 400, to enable the piezoelectric member 200 to work normally.

In this embodiment, the flexible connecting member 400 is arranged so that when the piezoelectric member 200 and the movable member 300 move, the other end of the flexible connecting member 400 moves with the piezoelectric member 200 and the movable member 300. Since the flexible connecting member 400 is a flexible structure, the flexible connecting member 400 is similar to a drag chain structure or a tank chain structure. The reciprocating motion of the piezoelectric member 200 and the movable member 300 will not cause the flexible connecting member 400 to be entangled or damaged, and has high reliability.

In this embodiment, an unbent part of the flexible connecting member 400 is arranged opposite to the movable member 300 or the piezoelectric member 200 in the third direction Z, that is, the unbent part of the flexible connecting member 400 may be located on one side of the movable member 300 or the piezoelectric member 200, so that when the flexible connecting member 400 moves with the movable member 300, it has a sufficient length to match the position of the other end of the flexible connecting member 400.

Exemplarily, a first end 410 of the flexible connecting member 400 is configured to be connected to the signal source and arranged on the fixed component 100. A second end 420 of the flexible connecting member 400, which is arranged opposite to the first end 410, is connected to the piezoelectric member 200 and/or the movable member 300. The flexible connecting member 400 has a bent part 430 located between the first end 410 and the second end 420, and the position of the bent part 430 changes as the second end 420 of the flexible connecting member 400 moves. In some optional embodiments, as shown in FIG. 1, the first end 410 of the flexible connecting member 400 passes through a side wall of the fixed component 100 so as to be connected to the signal source.

Optionally, the bent part 430 of the flexible connecting member 400 is in the shape of an arc with a bending angle greater than 180 degrees to reduce the bending stress of the flexible connecting member 400 and reduce the probability of damage to the flexible connecting member 400 due to bending.

In some optional embodiments, the flexible connecting member 400 can be supported on the fixed component 100. For example, in the portion of the flexible connecting member 400 that is not bent, one side of the portion not bent in the thickness direction faces the piezoelectric member 200 or the movable member 300, and the other side of the portion not bent in the thickness direction faces the fixed component 100 and is supported on the fixed component 100, so that the flexible connecting member 400 will not collapse due to gravity, the pulling force on the second end 420 of the flexible connecting member 400 is reduced, and the movement of the piezoelectric member 200 and the movable member 300 will not be affected. It should be noted that the flexible connecting member 400 may be directly or indirectly supported on the fixed component 100, which is not limited in this embodiment.

Of course, it can be understood that the flexible connecting member 400 may not be supported on other components. For example, in a state in which the piezoelectric motor 10 is installed in the electronic device, an extension direction of the portion of the flexible connecting member 400 that is not bent is the vertical direction, in this case, the flexible connecting member 400 will not be deformed and affect the movement of the piezoelectric member 200 and the movable member 300.

For example, the flexible connecting member 400 can be a flexible printed circuit board, which is convenient for material acquisition, facilitates the manufacture, and can reduce the cost.

For example, the piezoelectric motor 10 may also include a sliding shaft (not shown in the figure), one end of the sliding shaft is arranged on the fixed component 100 to be slidable in the moving direction (i.e., the first direction) of the piezoelectric member 200, and the other end of the sliding shaft passes through a hole formed by the bending portion 430 of the flexible connecting member 400, that is, the second end 420 of the flexible connecting member 400 is connected to the piezoelectric member 200 and/or the movable member 300 after bypassing the sliding shaft. The sliding shaft can also support the bending portion 430 of the flexible connecting member 400 to reduce the probability of damage of the flexible connecting member 400 and improve reliability. When the piezoelectric member 200 and the movable member 300 move, the sliding shaft is pushed by the flexible connecting member 400 to move synchronously relative to the fixed component 100, so that the sliding shaft can always support the bending portion to improve stability.

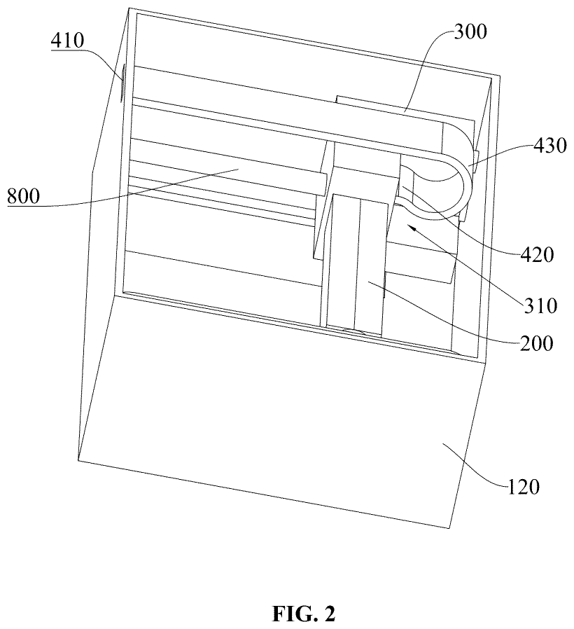

In some optional embodiments, as shown in FIG. 2, the movable member 300 is provided with a notch 310, and the other end of the flexible connecting member 400 is connected to a notch wall of the notch 310. In the moving direction of the movable member 300, the notch 310 extends from one side to an outer surface of the movable member 300 in the moving direction of the movable member 300. By providing the notch 310, the second end 420 of the flexible connecting member 400 is connected to the notch wall of the notch 310. Compared with the manner of being connected to the outer surface of the movable member 300, in one aspect, this arrangement facilitates the formation of a curved portion 430 in an arc shape by the flexible connecting member 400, and in another aspect, this arrangement also reduces the space required for the combination of the flexible connecting member 400 and the movable member 300 in a direction perpendicular to the moving direction of the movable member 300 (such as the second direction Y or the third direction Z), which is further conducive to the miniaturization of the piezoelectric motor 10.

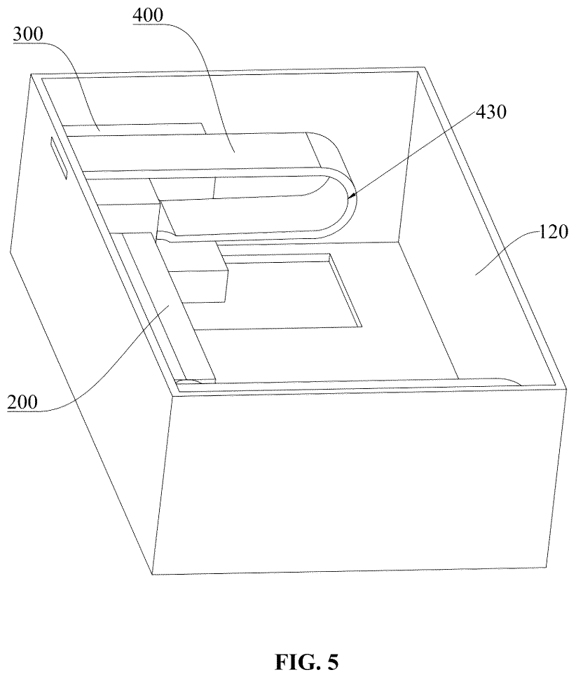

Exemplarily, the flexible connecting member 400 includes a first connection state and a second connection state. The piezoelectric member 200 and/or the movable member 300 is configured to drive the flexible connecting member 400 to switch between the first connection state and the second connection state different from the first connection state. FIG. 2 is a schematic diagram of the flexible connecting member 400 in the first connection state, and FIG. 5 is a schematic diagram of the flexible connecting member 400 in the second connection state.

In this embodiment, when the flexible connecting member 400 is in the first connection state, as shown in FIG. 2, the bent part 430 of the flexible connecting member 400 is placed in the notch 310 to be accommodated and protected by the notch 310 to prevent the bent part 430 from contacting the fixed component 100 and being damaged. It should be noted that when the flexible connecting member 400 is in the first connection state, the position of the movable member 300 is an extreme position for the movable member 300 to move relative to the fixed component 100. The extreme position can be limited by the inner wall of the fixed component 100, and can also be limited by other limiting structures, which is not limited in this embodiment.

When the flexible connecting member 400 is in the second connection state, as shown in FIG. 5, the bent part 430 of the flexible connecting member 400 is entirely located outside the notch 310. Of course, it is understandable that when the flexible connecting member 400 is in the second connection state, a portion of the bent part 430 of the flexible connecting member 400 may be located inside the notch 310 and another portion may be located outside the notch 310, which is not limited in this embodiment. It is to be noted that when the flexible connecting member 400 is in the second connection state, the bent part 430 of the flexible connecting member 400 is suspended in the fixed component 100 and will not contact the inner wall of the fixed component 100. It should also be noted that when the movable member 300 is located in the position shown in FIG. 5 which is the other extreme position of the movable member 300, at this time, the movable member 300 may abut against another inner wall of the fixed component 100, or the fixed component 100 is provided with a position-limiting structure to limit the position of the movable member 300.

For example, the second end 420 of the flexible connecting member 400 can be directly electrically connected to the piezoelectric member 200, or, as shown in FIG. 2, the movable member 300 is a conductor, and the flexible connecting member 400 is electrically connected to the piezoelectric member 200 through the movable member 300, so that the structure of the piezoelectric motor 10 can be simpler and facilitate assemble and disassemble. Optionally, the second end 420 of the flexible connecting member 400 is connected to the movable member 300, so that the flexible connecting member 400 and the movable member 300 are both connected and electrically connected, realizing the multiple usages of a connection position, reducing the setting of the connection position, and improving the connection reliability.

Optionally, as shown in FIG. 1, the fixed component 100 includes a housing 120. The housing 120 in this embodiment is in the shape of a rectangular parallelepiped with an opening, and a cover plate may or may not be provided at the opening. In this embodiment, the piezoelectric member 200, the movable member 300 and the flexible connecting member 400 are all arranged in the housing 120, so that the housing 120 can protect the piezoelectric member 200, the movable member 300 and the flexible connecting member 400. The two opposite side walls of the housing 120 can limit the movement limit of the movable member 300 and the piezoelectric member 200, without the need to set an additional limit structure, thereby enriching the function of the housing 120.

Optionally, as shown in FIG. 3, the fixed component 100 further includes a fixed member 130 and an elastic member 140 both arranged in the housing 120. The friction surface 110 is provided on the fixed member 130, and the elastic member 140 is provided on the side of the fixed member 130 facing away from the piezoelectric member 200 and abuts against the inner walls of the housing 120, so as to drive the fixed member 130 to always have a tendency to abut against the piezoelectric member 200, so that a friction force is generated between the piezoelectric member 200 and the fixed member 130 to drive the piezoelectric member 200 to move relative to the fixed member 130.

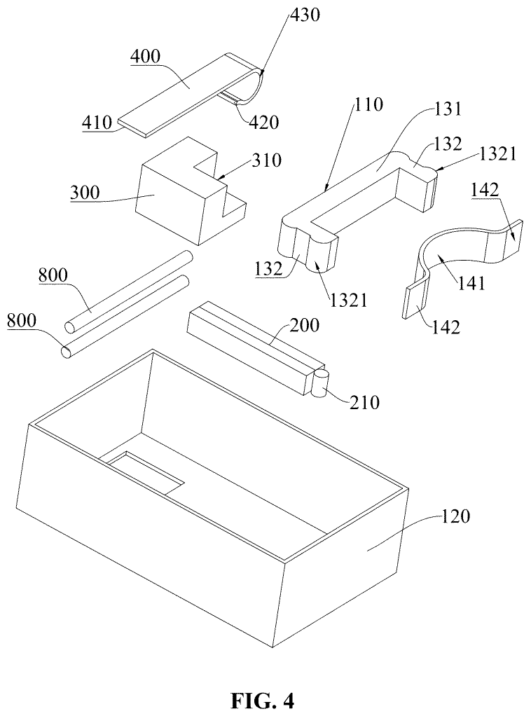

For example, as shown in FIG. 4, the fixed member 130 includes a first fixed part 131 and two second fixed parts 132, and the two second fixed parts 132 are spaced and connected to the same side of the first fixed part 131. For example, the two second fixed parts 132 are connected to a same side of the first fixed part 131 in the second direction Y at an interval. Specifically, the second fixed part 132 is connected to the side of the first fixed part 131 facing away from the piezoelectric member 200, and the friction surface 110 is provided on the first fixed part 131. At least part of the elastic member 140 is located between the two second fixed parts 132 so that the second fixed parts 132 can limit the position of the elastic member 140 in the first direction X, and the elastic member 140 abuts against the surface of the first fixed part 131 facing away from the friction surface 110 so as to apply a positive force to the first fixed part 131 for the first fixed part 131 to contact the piezoelectric friction head 210.

Please continue to refer to FIG. 4. Surfaces of the two second fixed parts 132 facing away from each other are provided with protrusions 1321 respectively, and the protrusions 1321 are configured to abut against inner walls of the housing 120. Exemplarily, the contact between the protrusion 1321 and the inner wall of the housing 120 may be point contact, line contact or surface contact, which is not limited in this embodiment. By providing the protrusion 1321, the friction of the fixed member 130 moving relative to the housing 120 is reduced, thereby reducing the force applied by the elastic member 140 when driving the fixed member 130 to move.

Further optionally, as shown in FIG. 4, the elastic member 140 includes an arc-shaped part 141 and two abutment parts 142 connected to two ends of the arc-shaped part 141, at least part of the arc-shaped part 141 is located between the two second fixed parts 132, and the arc-shaped part 141 abuts against the first fixed part 131 of the fixed member 130. The two abutment parts 142 abut against the inner walls of the housing 120. For example, the two abutment parts 142 are arranged in one-to-one correspondence between the two second fixed parts 132 and the inner walls of the housing 120. By providing the arc-shaped part 141 in an arc shape, the fixed member 130 is elastically pushed to form the tendency of moving toward the piezoelectric member 200, thereby avoiding damage to the piezoelectric member 200, and having high reliability.

For example, the piezoelectric friction head 210 may be in a cylindrical shape, and a circumferential outer wall of the piezoelectric friction head 210 abuts against the friction surface 110 and is connected to the piezoelectric member 200, so that when the piezoelectric member 200 is deformed, the piezoelectric friction head 210 smoothly rubs against the friction surface 110 and generates a friction force to drive the movable member 300 to move. For the specific structure of the piezoelectric member 200, reference may be made to the related art, such as the piezoelectric block in the related art. At least part of the piezoelectric member 200 is made of piezoelectric material and has the performance of deforming according to the piezoelectric signal, which is not described in detail in this embodiment here.

For example, the piezoelectric motor 10 further includes a guide structure 800 extending in the first direction X, the movable member 300 is slidably matched with the guide structure 800, and is configured to slide in the extension direction of the guide structure 800. Based on the guidance of the guide structure 800, the movement of the movable member 300 and the piezoelectric member 200 is more directional, thereby ensuring directionality of the driving to the moving member 20 of the electronic device.

For example, the guide structure 800 is a guide rod, and is arranged to pass through the movable member 300, and the movable member 300 can slide along the guide rod.

In some optional embodiments, the housing 120 is provided with a through hole (not shown), and the moving member 20 of the electronic device is configured to pass through the through hole and is connected to the movable member 300.

An electronic device is further provided according to this embodiment, which includes the piezoelectric motor 10 as described above. An installation space required to be reserved for the piezoelectric motor 10 in the electronic device provided in this embodiment can be small, so the electronic device has a higher flexibility.

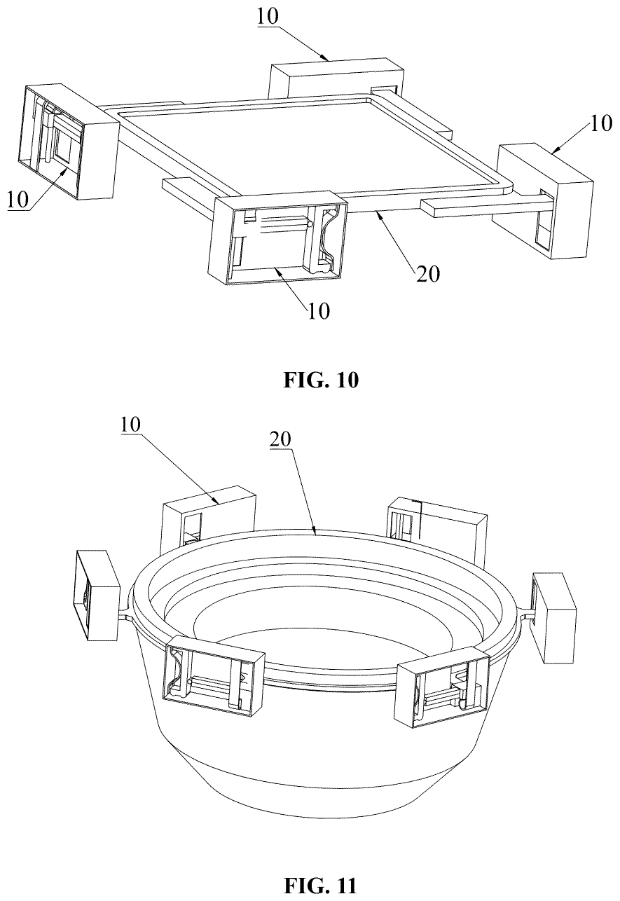

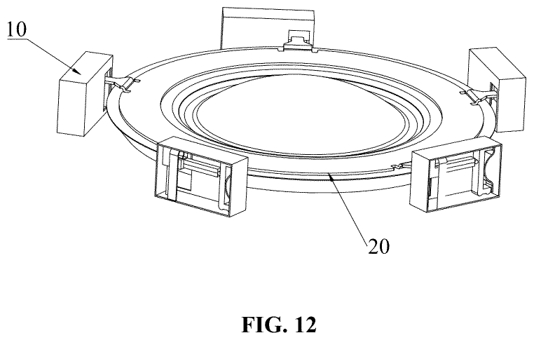

For example, as shown in FIG. 10 to FIG. 12, the electronic device may include a device body (not shown) and a moving member 20, and the moving member 20 is movable relative to the device body. The fixed component 100 of the piezoelectric motor 10 is arranged on the device body, and the moving member 20 is connected to the movable member 300, so that the movable member 300 can drive the moving member 20 to move.

For example, the electronic device can be AR, VR, camera, etc., which is not limited in this embodiment. The moving member 20 can be a display component, an optical component (or optical bracket) for generating a zoom function, or a lens (or optical module) of an electronic product. When the size of the moving member 20 is large, multiple piezoelectric motors 10 can be connected at the same time to improve the stability and reliability of the movement.

It is to be noted that the electronic device in this embodiment may also include mobile phones, tablet personal computers, laptops, personal digital assistants (PDAs), personal computers, laptops, vehicle-mounted devices, wearable devices, VR helmets, fixed-line handsets (pickups), medical auxiliary equipment (such as hearing aids), various headphones (such as wireless headphones or wired headphones) and other devices with speakers. The present application embodiment does not impose any special restrictions on the specific form of the above-mentioned electronic devices.

### Embodiment Two

The piezoelectric motor 10 and the electronic device provided in this embodiment are different from those in the embodiment one in that they are not provided with the flexible connecting member 400.

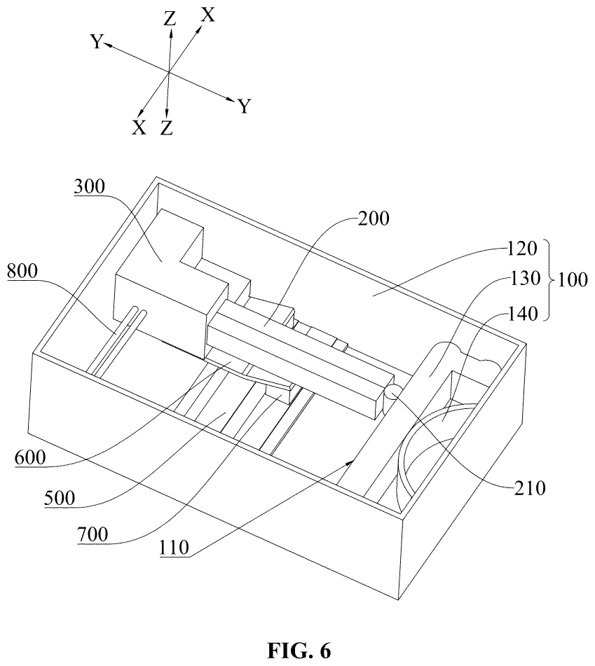

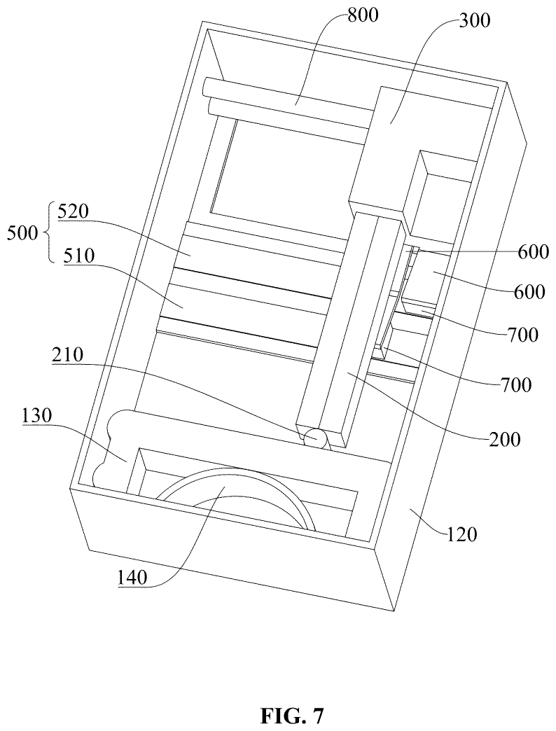

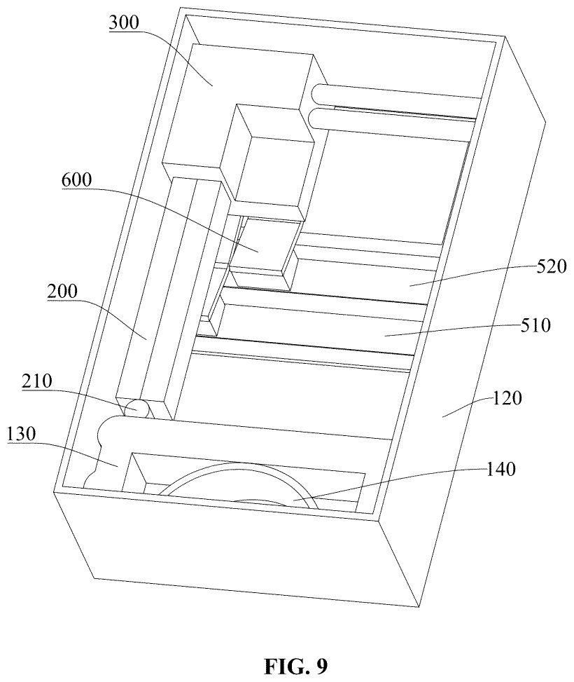

Specifically, as shown in FIG. 6 to FIG. 9, the piezoelectric motor 10 includes not only a fixed component 100, a piezoelectric member 200 and a movable member 300, but also a conductive structure 500 and a connecting component 600. The conductive structure 500 extends in a moving direction of the movable member 300. For example, the conductive structure 500 may be arranged at the bottom of the housing 120 and is configured to extend in the first direction X. One end of the connecting component 600 is in sliding contact with and electrically connected to the conductive structure 500, and the other end of the connecting component 600 is arranged on the piezoelectric member 200 and/or the movable member 300 and is electrically connected to the piezoelectric member 200, so that the connecting component 600 may move with the movement of the piezoelectric member 200 and/or the movable member 300, and the connecting component 600 is electrically connected to the conductive structure 500 and the piezoelectric member 200. In addition, during the movement of the connecting component 600 with the piezoelectric member 200 and/or the movable member 300, the connecting component 600 is always in sliding contact with and electrically connected to the conductive structure 500.

By providing the connecting component 600, during the movement of the piezoelectric member 200, the piezoelectric member 200 can always be electrically connected to an external signal source through the connecting component 600 and the conductive structure 500, thereby improving the reliability of signal transmission.

In some optional embodiments, the conductive structure 500 is a circuit board, a top surface of the circuit board has a metal layer, and the connecting component 600 is in sliding contact with and electrically connected to the metal layer.

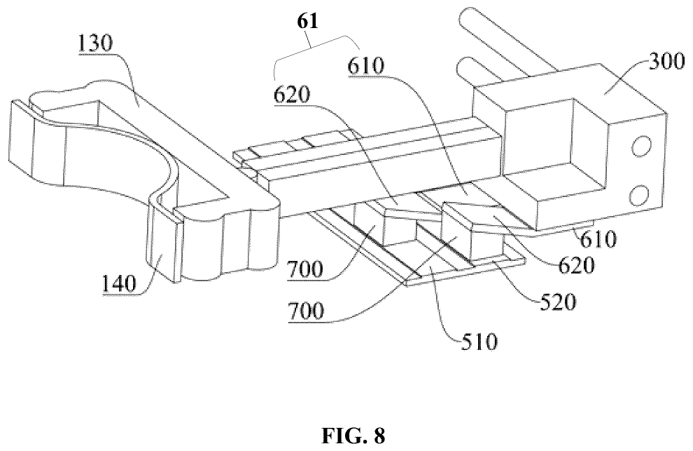

For example, as shown in FIG. 8, the connecting component 600 includes a conductive member 61 and a carbon brush 700 arranged on the conductive member 61 and electrically connected to the conductive member. The conductive member 61 is arranged on the piezoelectric member 200 and/or the movable member 300 and electrically connected to the piezoelectric member 200. The carbon brush 700 is in sliding contact with and electrically connected to the metal layer of the conductive structure 500.

The carbon brush 700 is also called an electric brush, which is a sliding contact member. The main function of the carbon brush 700 is to rub against the metal while conducting electricity. The friction conduction between the carbon brush 700 and the metal layer is different from the friction conduction between metals. When metal conducts electricity by rubbing against metal, the friction force may increase, and the contacting areas may sinter together. However, since carbon and metal are two different substances, the friction force will not increase when the carbon brush 700 rubs against the metal layer, and the carbon brush 700 and the metal layer will not sinter together, therefore, this configuration achieves a high reliability and stability.

For example, as shown in FIG. 8, two groups of connecting components 600 are provided, and also two metal layers on the conductive structure 500 are provided, the two metal layers are respectively a first metal layer 510 and a second metal layer 520, the carbon brush 700 of one group of connecting component 600 is in sliding contact with the first metal layer 510, and the carbon brush 700 of the other group of connection component 600 is in sliding contact with the second metal layer 520.

In some optional embodiments, the conductive member 61 is electrically connected to the movable member 300, so that the conductive member 61 and the piezoelectric member 200 are electrically connected through the movable member 300, thereby realizing the multiple usages of the movable member 300.

Optionally, please continue to refer to FIG. 8, the movable member 300 and the carbon brush 700 are arranged on opposite sides of the conductive member. For example, the movable member 300 is arranged at the top of the conductive member in the thickness direction, and the carbon brush 700 is arranged at the bottom of the conductive member in the thickness direction. Moreover, the conductive member is bent toward the movable member 300, so that the conductive member can apply a pre-pressure caused by the deformation to the carbon brush 700, thereby enabling the carbon brush 700 to better contact the metal layer and ensuring the conductive effect.

For example, the conductive member 61 includes a first spring sheet 610 and a second spring sheet 620 that are arranged at an obtuse angle and connected to each other. The first spring sheet 610 is arranged on the movable member 300 and is electrically connected to the movable member 300 to realize the electrical connection between the first spring sheet 610 and the piezoelectric member 200. The carbon brush 700 is arranged at one end of the second spring sheet 620 facing away from the first spring sheet 610. The first spring sheet 610 and the second spring sheet 620 are arranged at an obtuse angle, which is convenient for matching the positions of the conductive structure 500 and the movable member 300, and can also elastically press the carbon brush 700, and the structure is simple and it is easy to form the structure.

Beneficial effects of the present application:

In the piezoelectric motor and electronic device according to the present application, the fixed component is provided with a friction surface, the piezoelectric member is in contact with the friction surface through the piezoelectric friction head, so that the piezoelectric member can move relative to the fixed component, and the movable member is connected to the piezoelectric member, so that the movable member and the piezoelectric member move synchronously relative to the fixed component. The friction surface is set on the fixed component, but not on the movable member, so that the size of the movable member does not need to be designed large, and the movable member does not need to reserve at least one time a stroke space in the moving direction, but may just move within a set stroke, and a required moving stroke of the piezoelectric member may also be equal to the set stroke, and does not need to be set greater than the set stroke. The length of the friction surface may also be equal to the set stroke, and does not need to be set greater than the set stroke, so that the overall size of the piezoelectric motor can be small, which facilitates miniaturization of the piezoelectric motor, and enables the piezoelectric motor to be applied in electronic devices with high size requirements, and to have a wider range of applications.

The other structures of this embodiment are similar to those of the first embodiment and have similar beneficial effects, which are not limited in this embodiment.

It is to be noted that the above are only preferred embodiments of the present application and the technical principles used. The person skilled in the art will understand that the present application is not limited to the embodiments described herein, and that various obvious changes, readjustments and substitutions can be made by the person skilled in the art without departing from the scope of protection of the present application. Therefore, although the present application has been described in more detail through the above embodiments, the present application is not limited to the above embodiments, and may also include more other equivalent embodiments without departing from the concept of the present application, and the scope of the present application is determined by the scope of the appended claims.

What is claimed is:

1. A piezoelectric motor, comprising:
a fixed component provided with a friction surface;
a piezoelectric member provided with a piezoelectric friction head, wherein the piezoelectric friction head is configured to abut against the friction surface, to enable the piezoelectric member to be moveable relative to the fixed component; and
a movable member, wherein the movable member is connected to the piezoelectric member, and the piezoelectric member is configured to move to drive the movable member to move relative to the fixed component.

2. The piezoelectric motor according to claim 1, wherein the piezoelectric motor further comprises a flexible connecting member;
one end of the flexible connecting member is connected to the fixed component and is electrically connected to a signal source, and the other end of the flexible connecting member is bent toward the piezoelectric member or the movable member and is connected to at least one of the piezoelectric member and the movable member; and
the flexible connecting member is electrically connected to the piezoelectric member.

3. The piezoelectric motor according to claim 2, wherein the movable member is provided with a notch, the other end of the flexible connecting member is connected to a notch wall of the notch, and the notch extends from one side of the movable member to an outer surface of the movable member in the moving direction of the movable member; and
the flexible connecting member comprises a first connection state and a second connection state, and when the flexible connecting member is in the first connection state, a bent part of the flexible connecting member is placed in the notch; and when the flexible connecting member is in the second connection state, the bent part of the flexible connecting member is entirely or partially located outside the notch.

4. The piezoelectric motor according to claim 2, wherein the movable member is a conductor, and the flexible connecting member is electrically connected to the piezoelectric member through the movable member.

5. The piezoelectric motor according to claim 1, further comprising a conductive structure and a connecting component;
wherein the conductive structure extends in a moving direction of the movable member and is electrically connected to a signal source; and
one end of the connecting component is in sliding contact with and electrically connected to the conductive structure, and the other end of the connecting component is arranged on at least one of the piezoelectric member and the movable member and is electrically connected to the piezoelectric member.

6. The piezoelectric motor according to claim 5, wherein the connecting component comprises a conductive member and a carbon brush arranged on and electrically connected to the conductive member;
wherein the conductive member is arranged on at least one of the piezoelectric member and the movable member and is electrically connected to the piezoelectric member, and the carbon brush is in sliding contact with and electrically connected to the conductive structure.

7. The piezoelectric motor according to claim 6, wherein the conductive member is electrically connected to the movable member, the movable member is electrically connected to the piezoelectric member, the movable member and the carbon brush are arranged on opposite sides of the conductive member, and the conductive member is bent toward the movable member.

8. The piezoelectric motor according to claim 6, wherein the movable member is arranged at a top of the conductive member in the thickness direction, and the carbon brush is arranged at a bottom of the conductive member in the thickness direction; and
the conductive member is bent toward the movable member to enable the conductive member to apply a pre-pressure caused by a deformation to the carbon brush.

9. The piezoelectric motor according to claim 6, wherein the conductive member comprises a first spring sheet and a second spring sheet that are arranged at an obtuse angle and connected to each other;
the first spring sheet is arranged on the movable member and is electrically connected to the movable member to realize an electrical connection between the first spring sheet and the piezoelectric member;
the carbon brush is arranged at one end of the second spring sheet facing away from the first spring sheet; and
the first spring sheet and the second spring sheet are arranged at an obtuse angle.

10. The piezoelectric motor according to claim 6, wherein two groups of connecting components are provided, and two metal layers on the conductive structure are provided;
the two metal layers are respectively a first metal layer and a second metal layer; and
a carbon brush of one group of connecting component is in sliding contact with the first metal layer, and a carbon brush of the other group of connection component is in sliding contact with the second metal layer.

11. The piezoelectric motor according to claim 1, wherein the fixed component comprises a housing, a fixed member and an elastic member;
the fixed member and the elastic member are both arranged in the housing;
the friction surface is provided on the fixed member; and
the elastic member abuts between an inner wall of the housing and the fixed member, and is configured to drive the fixed member to have a tendency to abut against the piezoelectric member.

12. The piezoelectric motor according to claim 11, wherein the fixed member comprises a first fixed part and two second fixed parts, the two second fixed parts are spaced and connected to a same side of the first fixed part;
the friction surface is provided on the first fixed part, and the elastic member abuts against the first fixed part; and
surfaces of the two second fixed parts facing away from each other are provided with protrusions respectively, and the protrusions are configured to abut against inner walls of the housing.

13. The piezoelectric motor according to claim 11, wherein the elastic member comprises an arc-shaped part and two abutment parts connected to two ends of the arc-shaped part, the arc-shaped part abuts against the fixed member, and the abutment parts abut against the inner walls of the housing.

14. The piezoelectric motor according to claim 1, further comprising a guide structure extending in a first direction, wherein the movable member is slidably matched with the guide structure and is slidable in the extension direction of the guide structure.

15. An electronic device, comprising a piezoelectric motor; wherein the piezoelectric motor comprises:
a fixed component provided with a friction surface;
a piezoelectric member provided with a piezoelectric friction head, wherein the piezoelectric friction head is configured to abut against the friction surface, to enable the piezoelectric member to be moveable relative to the fixed component; and
a movable member, wherein the movable member is connected to the piezoelectric member, and the piezoelectric member is configured to move to drive the movable member to move relative to the fixed component.

16. The electronic device according to claim 15, wherein the piezoelectric motor further comprises a flexible connecting member;
one end of the flexible connecting member is connected to the fixed component and is electrically connected to a signal source, and the other end of the flexible connecting member is bent toward the piezoelectric member or the movable member and is connected to at least one of the piezoelectric member and the movable member; and
the flexible connecting member is electrically connected to the piezoelectric member.

17. The electronic device according to claim 16, wherein the movable member is provided with a notch, the other end of the flexible connecting member is connected to a notch wall of the notch, and the notch extends from one side of the movable member to an outer surface of the movable member in the moving direction of the movable member; and
the flexible connecting member comprises a first connection state and a second connection state, and when the flexible connecting member is in the first connection state, a bent part of the flexible connecting member is placed in the notch; and when the flexible connecting member is in the second connection state, the bent part of the flexible connecting member is entirely or partially located outside the notch.

18. The electronic device according to claim 16, wherein the movable member is a conductor, and the flexible connecting member is electrically connected to the piezoelectric member through the movable member.

19. The electronic device according to claim 15, further comprising a conductive structure and a connecting component;
wherein the conductive structure extends in a moving direction of the movable member and is electrically connected to a signal source; and
one end of the connecting component is in sliding contact with and electrically connected to the conductive structure, and the other end of the connecting component is arranged on at least one of the piezoelectric member and the movable member and is electrically connected to the piezoelectric member.

20. The electronic device according to claim 19, wherein the connecting component comprises a conductive member and a carbon brush arranged on and electrically connected to the conductive member;
wherein the conductive member is arranged on at least one of the piezoelectric member and the movable member and is electrically connected to the piezoelectric member, and the carbon brush is in sliding contact with and electrically connected to the conductive structure.
